(19) United States
(12) Patent Application Publication
(10) Pub. No.: US 2017/0214711 A1
(43) Pub. Date: Jul. 27, 2017

(54) CREATING A SECURITY REPORT FOR A CUSTOMER NETWORK

(71) Applicant: HEWLETT PACKARD ENTERPRISE DEVELOPMENT LP, Houston, TX (US)

(72) Inventors: Simon Ian Arnell, Bracknell (GB); Neil Passingham, Bracknell (GB); Marco Casassa Mont, Bristol (GB)

(21) Appl. No.: 15/500,397

(22) PCT Filed: Jul. 31, 2014
(86) PCT No.: PCT/US2014/049191

§ 371 Date: Jan. 30, 2017

(51) Int. Cl. H04L 29/06; H04L 12/24; G06N 5/04; H04L 12/26

(52) U.S. Cl. CPC H04L 63/1433; H04L 43/062; H04L 41/145; G06N 5/04

(57) ABSTRACT

Creating a security report for a customer network includes obtaining from a customer network, security information about the customer network, preparing, based on modification rules, the security information to create modified security information, analyzing, based on big data threat analytics, the security threats to create a number of metrics, refining the number of metrics using a refining model, creating, based on the refined number of metrics used as an input for model-based predictive analytics and the security threats, a security report representing security intelligence for the customer network in which the number of metrics are refined by a refining model and used as an input for the model-based predictive analytics.

### BACKGROUND

A customer network includes a number of devices, systems, and services to allow an organization to exchange data between the number of devices, systems, and services. Often, a security operations centre (SOC) monitors the customer network to identify security threats that may impact data transmitted over the customer network, security performance issues with the customer network, and stages of incident management lifecycles of the customer network.

### BRIEF DESCRIPTION OF THE DRAWINGS

The accompanying drawings illustrate various examples of the principles described herein and are a part of the specification. The examples do not limit the scope of the claims.

FIG. 1 is a diagram of an example of a system for creating a security report for a customer network, according to one example of principles described herein.

FIG. 2 is a diagram of an example of a system for creating a security report for a customer network, according to one example of principles described herein.

FIG. 3 is a diagram of an example of a security report for a customer network, according to one example of principles described herein.

FIG. 4 is a flowchart of an example of a method for creating a security report for a customer network, according to one example of principles described herein.

FIG. 5 is a flowchart of an example of a method for creating a security report for a customer network, according to one example of principles described herein.

FIG. 6 is a diagram of an example of a creating system, according to one example of principles described herein.

FIG. 7 is a diagram of an example of a creating system, according to one example of principles described herein.

Throughout the drawings, identical reference numbers designate similar, but not necessarily identical, elements.

### DETAILED DESCRIPTION

As mentioned above, a security operations centre (SOC) monitors a customer network to identify security threats that may impact data transmitted over the customer network, security performance issues with the customer network, and stages of incident management lifecycles of the customer network. Often, a SOC is a response and investigation mechanism for a customer network. For example, the SOC receives security information of direct high priority events, such as a recognized intrusion detection signature or detection of suspicious activity on the basis of collection and correlation of structured log data, from multiple systems using security information and event management systems (SIEM). The SOC determines whether or not the received security information is an indication of a security threat. If the security information indicates a security threat, the SOC is used to determine what action to take to remediate the security threat.

In one example, particularly when the SOC's operation is delivered as an outsourced service, there is limited contextual information about current security threats against a customer network. Further, there is a gap in a customer network security lifecycle management processes. For example, companies carry out strategic, long-term risk assessment activities, at the business level, to identify security threats and mitigate the security threats with suitable policies and controls. Further, companies heavily invest in SIEM to collect large amount of information from their information technology (IT) infrastructure, for compliance and governance purposes. However, information gathered at this level is usually not fully leveraged to derive security intelligence for higher-level strategic security risk assessment, except by expensive and manual processes performed by a user of the SOC. This can be a burdensome task for a user.

The principles described herein include a method and a system for creating a security report for a customer network. Such a method includes obtaining from a customer network, security information about the customer network, preparing, based on modification rules, the security information to create modified security information, analyzing, via big data threat analytics, the modified security information to create a number of metrics and identify security threats, refining the number of metrics using a refining model, creating, based on the refined number of metrics used as an input for model-based predictive analytics and the security threats, a security report representing security intelligence for the customer network. As a result, the security report illustrates trends and provides historical and/or benchmark reports among a community of customers to improve strategic security risk assessment.

In the present specification and in the appended claims, the term “customer network” is meant to be understood broadly as devices, systems, services, or combinations thereof for a specific customer such as an individual or an organization. For example, the customer network may include actual network components such as routers, domain name system (DNS) servers, firewalls, other components, or combinations thereof that execute on the customer network. In one example, the customer network may be for one specific customer or for a number of customers. Further, the customer network may be a SDN network. In one example, a SDN network includes a SDN controller, flow tables, a number of software controlled switches, routers, or wireless access points, and instructions processed by the switches, routers, and wireless access points to define the forwarding behavior of data packets. Further, the term switch can apply equally to a wide area network (WAN) router, wireless access point, or other SDN networking device. In one example, the SDN controller in the SDN network makes decisions about how network traffic is processed by instructing switches within the SDN network to define the forwarding behavior of data packets traveling across the SDN network. Further, a SDN network decouples the control and data plane enabling control functions to be defined by the end user and performed by commodity hardware. As a result, applications can be written for the network layer that provide increased intelligence for switching decisions, better supporting the data and applications that exist on the SDN networks. Such applications can provide finer-grained control of the SDN network in terms of, for example, quality of service and security.

In the present specification and in the appended claims, the term “security information” is meant to be understood broadly as data related to a customer network that represents a state of security for the customer network. In one example, the security information includes unstructured data, semi-structured data, events related to the customer network, or combinations thereof. In one example, events may include user events, system events, vulnerability events, domain name system (DNS) events, other events, or combinations thereof. Further, unstructured data may include data, metadata, or other data of a social media service.

In the present specification and in the appended claims, the term “modified security information” is meant to be understood broadly as security information that has been modified. In one example, the security information may be modified by a preparing engine. In one example, the preparing engine modifies the security information by filtering the security information to discard uninteresting or duplicate security information. In another example, the preparing engine modifies the security information by normalizing the security information to be properly analyzed and compared. In yet another example, the preparing engine modifies the security information by correlating the security information to provide additional context or other information. In still another example, the preparing engine modifies the security information by determining if the security information indicates a security threat.

In the present specification and in the appended claims, the term “modification rule” is meant to be understood broadly as a mechanism to determine if security information obtained from the customer network may become a security threat to the customer network. In one example, the modification rule may identify specific users, devices, system, or combinations thereof that may pose a security threat to the customer network.

In the present specification and in the appended claims, the term “metrics” is meant to be understood broadly as parameters created by a big data threat analytics engine and sent to a model-based predictive analytics engine for analysis. In one example, metrics may be based on a statistical and threat analysis of security information gathered from IT security event and log management systems, results from predictive simulations, outputs of unstructured data, or combinations thereof. Further, the metrics may be based on an output of big data threat analytics. In one example, the output of big data threat analytics may be a parameter that provides more accurate predictive results for model-based predictive analytics.

In the present specification and in the appended claims, the term “security report” is meant to be understood broadly as a mechanism for illustrating trends and provides historical and/or benchmark reports among a community of customers to improve strategic security risk assessment. In one example, a historical report may include a history of security threats for a specific customer network. Further, a benchmark report may include security threats for a specific customer network compared against security threats for all other customer networks. In one example, the security report may be displayed via a display on a user device. In another example, the security report may be displayed via displays in a SOC center to a number of analysts and/or personnel.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

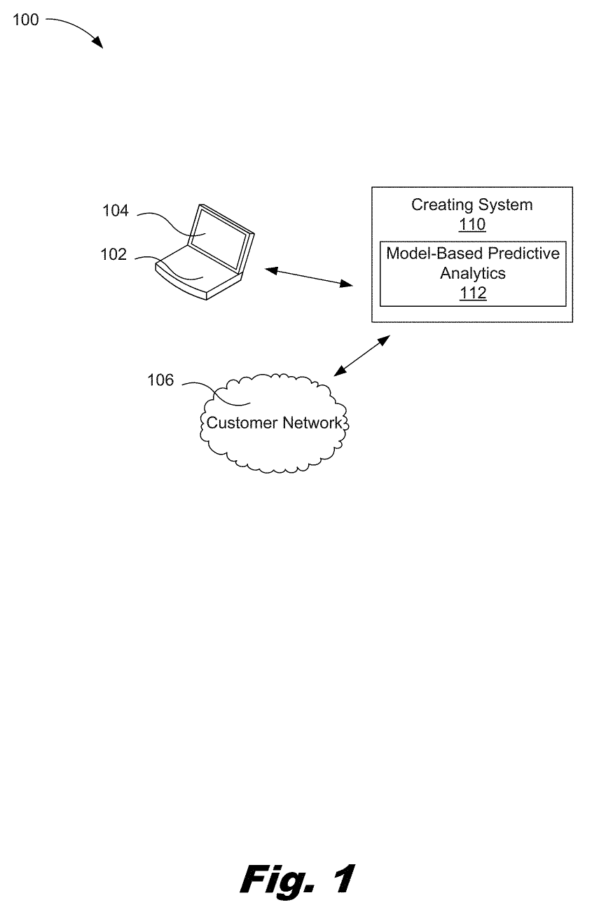

Referring now to the figures, FIG. 1 is a diagram of an example of a system for creating a security report for a customer network, according to one example of principles described herein. As will be described below, a creating system is in communication with a network to obtain from a customer network, security information about the customer network. The creating system prepares, based on modification rules, the security information to create modified security information. Further, the creating system analyzes, via big data threat analytics, the modified security information to create a number of metrics and identify security threats. The creating system refines the number of metrics using a refining model. The creating system creates, based on the refined number of metrics used for model-based predictive analytics and the security threats, a security report representing security intelligence for the customer network.

As illustrated in FIG. 1, the system (100) includes a customer network (106). In one example, the customer network (106) incudes devices, systems, services, or combinations thereof for a specific customer such as an individual or an organization. Further, the customer network (106) may be for one specific customer or for a number of customers. In this example, the customer network (106) allows a specific customer to exchange data between the number of devices, systems, and services. Further, the customer network (106) may be a SDN network.

The system (100) further includes a creating system (110). In keeping with the given example, the creating system (110) obtains from a customer network (106), security information about the customer network (106). As mentioned above, the security information may be data related to the customer network (106) that represents a state of security for the customer network (106).

The creating system (110) further prepares, based on modification rules, the security information to create modified security information. In one example, once the security information is prepared to create modified security information, the modified security information is stored in a repository of the creating system (110).

Further, the creating system (110) analyzes, via big data threat analytics, the modified security information to create a number of metrics and identify security threats. In one example, a big data threat analytics engine in the creating system (110) obtains the modified security information from the repository, analyzes the modified security information, and creates the number of metrics and identifies the security threats.

The creating system (110) refines the number of metrics using a refining model. In one example, the refining model refines the metrics according to rules, common techniques, a current state of the customer network (106), or combinations thereof such that the refining model produce refined metrics. In one example, the refined metrics updates parameters for system models in a model library.

The creating system (110) creates, based on the refined number of metrics used as an input for model-based predictive analytics (112) and the security threats, a security report representing security intelligence for the customer network (106). In one example, the security report may be a historical report, a benchmarking report, other types of security reports, or combinations thereof for the customer network (106).

Further, the security report may be displayed. In this example, the security report may be displayed on a user device (102) via a display (104). As a result, the security report illustrates trends and provides historical and/or benchmark reports among a community of customers to improve strategic security risk assessment. More information about the creating system (110) will be described later on in this specification.

While this example has been described with reference to the creating system being located over the network, the creating system may be located in any appropriate location according to the principles described herein. For example, the creating system may be located in a user device, a server, a datacenter, a customer network, other locations, or combinations thereof.

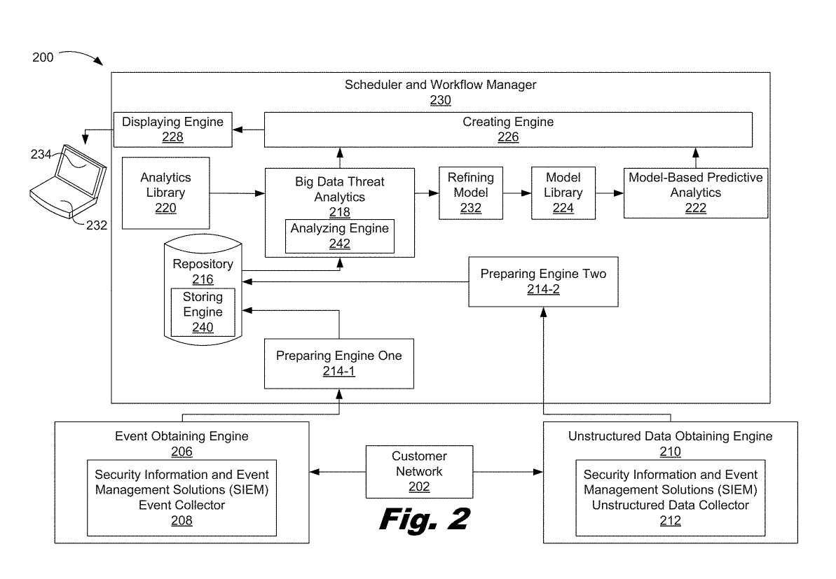

FIG. 2 is a diagram of an example of a system for creating a security report for a customer network, according to one example of principles described herein. As mentioned above, a creating system is in communication with a network to obtain from a customer network, security information about the customer network. The creating system prepares, based on modification rules, the security information to create modified security information. Further, the creating system analyzes, via big data threat analytics, the modified security information to create a number of metrics and identify security threats. The creating system refines the number of metrics using a refining model. The creating system creates, based on the refined number of metrics used as an input for model-based predictive analytics and the security threats, a security report representing security intelligence for the customer network.

As illustrated in FIG. 2, the system (200) includes a customer network (202). As mentioned above, the customer network (202) incudes devices, systems, services, or combinations thereof for a specific customer such as an individual or an organization. Further, the customer network may be for one specific customer or for a number of customers. In this example, the customer network (202) allows a specific customer to exchange data between the number of devices, systems, and services. In one example, the devices may include user devices such as laptops, desktops, tablets, and other user devices. Further, systems may include servers, routers, networking cables, and other systems. The services may include applications that allow the devices and systems to operate within the customer network (202). In one example, the services may include third party services.

As will be described below, the system (200) includes a number of engines (206, 210, 214, 218, 220, 222, 226, 228, 240, 242). The engines (206, 210, 214, 218, 220, 222, 226, 228, 240, 242) refer to a combination of hardware and program instructions to perform a designated function. Each of the engines (206, 210, 214, 218, 220, 222, 226, 228, 240, 242) may include a processor and memory. In one example, the engines (206, 210, 214, 218, 220, 222, 226, 228, 240, 242) may include a separate processor and memory. In another example, the engines (206, 210, 214, 218, 220, 222, 226, 228, 240, 242) may include a common processor and memory that is shared by the engines (206, 210, 214, 218, 220, 222, 226, 228, 240, 242). The program instructions are stored in the memory and cause the processor to execute the designated function of the engine. In one example, the operations of the engines (206, 210, 214, 218, 220, 222, 226, 228, 240, 242) may be coordinated by a scheduler and workflow manager (230).

As mentioned above, the creating system (110) of FIG. 1 obtains, from the customer network (202), security information about the customer network (202). As mentioned above, the security information may be data related to the customer network (202) that represents a state of security for the customer network (202). Further, the event obtaining engine (206) may monitor and obtain security information with regard to file access, virtual private network (VPN) connections, DNS queries, and dynamic host configuration protocol (DHCP) requests. For example, the event obtaining engine (206) may use deep packet inspection at points of concentration within the customer network such as a DNS sever where security information of interest to the system (200) may be concentrated. In this example, the event obtaining engine (206) may obtain DNS traffic by recording conversations between requesting clients, resolvers, and name servers locally. In another example, an offloading network adapter that taps the customer network may be installed between a DNS server and a nearest switch in the customer network (202). In this example, an available switched port analyzer (SPAN) port or a passive tap may be used. Further, the event obtaining engine (206) may monitor the customer network (202) to determine if domains associated with the customer network (202) are to be included on a black list, a grey list, or a white list. As a result, the security information may be obtained from an event obtaining engine (206).

As illustrated in FIG. 2, the event obtaining engine (206) includes a SIEM event collector (208). In one example, the SIEM event collector (208) actively receives network based security logs and events from the customer network (202). In one example, the SIEM event collector (208) may include analytics to aid the system (200) obtaining security information about the customer network (202). As, a result, the event obtaining engine (206) may be used to obtain, from the customer network (202), security information such as file access, VPN connections, DNS queries, and DHCP request from the customer network (202).

In another example, an unstructured data obtaining engine (210) may be used to obtain, from the customer network (202), security information about the customer network (202). In this example, the unstructured data obtaining engine (210) may include a SIEM unstructured data collector (212) to obtain, from the customer network (202), security information about the customer network (202). In this example, the SIEM unstructured data collector (212) may obtain unstructured data such as sentiments from users uploading data to a social media service on the customer network (202). For example, the SIEM unstructured data collector (212) obtains unstructured data, such as current adverse sentiment about a company and/or a product from the customer network (202). In one example, the SIEM unstructured data collector (212) may include analytics to aid the system (200) to obtain from the customer network (202) the unstructured data to determine if the unstructured data may pertain to security information. In one example, the analytics may include common tools and techniques to determine if the unstructured data may pertain to security information. As a result, the unstructured data obtaining engine (210) may be used to obtain, from the customer network (202), security information about the customer network (202).

Once the security information is obtained via the event obtaining engine (206) or the unstructured data obtaining engine (210), the security information may be further processed by a number of preparing engines (214). In one example, the preparing engines (214) modify the security information by filtering the security information to discard uninteresting or duplicate security information. For example, uninteresting security information such as an unusual event that is known about and accepted not to be a security threat, can be determined, for example, via a white list. Further, duplicate security information may include the same security information that is obtained from the customer network (202) at different points in times. As a result, the preparing engines (214) modify the security information by filtering the security information to discard uninteresting or duplicate security information. In another example, the preparing engines (214) modify the security information by normalizing the security information to be properly analyzed and compared. For example, security information obtained from the event obtaining engine (206) may be different from security information obtained from the unstructured data obtaining engine (210). For example, the security information obtained from the event obtaining engine (206) may be related to events and the security information obtained from the unstructured data obtaining engine (210) may be related to sentiments. In this example, the preparing engines (214) may use common tools and techniques to modify the security information from the event obtaining engine (206) and the unstructured data obtaining engine (210) such that the security information may be properly analyzed and compared despite the differences in the security information. In yet another example, the preparing engines (214) modify the security information by correlating the security information with the outputs of the preparing engines (214), configuration information, white list information, black list information, or combinations thereof to provide additional context or configuration information. In still another example, the preparing engines (214) modify the security information by determining if the security information indicates a security threat. For example, the security information may be modified by the preparing engines (214) by tagging the security information as a security theat. As a result, a tag is added directly to the security information.

As illustrated, the system (200) includes preparing engine one (214-1). Preparing engine one (214-1) prepares the security data from the event obtaining engine (206). In one example, preparing engine one (214-1) prepares the security data from the event obtaining engine (206) based on modification rules, to create modified security information. In one example, the modification rules may identify specific users, organizations, devices, systems, and services that have posed a security threat to the customer network (202) in past situations. As a result, this information may be included in the modified security information and further analyzed by the system (200) to identify if specific users, organizations, devices, systems, and services are a security theat. As illustrated, the modified security information is sent from preparing engine one (214-1) to a repository (216) for long term storage.

As illustrated, the system (200) includes preparing engine two (214-2). Preparing engine two (214-2) prepares the security data from the unstructured data obtaining engine (210). In one example, preparing engine two (214-2) prepares the security information from the unstructured data obtaining engine (210), based on modification rules, to create modified security information. In one example, since the security information from the unstructured data obtaining engine (210) may be different from the security information from the event obtaining engine (206), the modification rules for the unstructured data obtaining engine (210) may be different for the modification rules for the event obtaining engine (206). For example, the modification rules for the unstructured data obtaining engine (210) may be based on processing security information related to sentiments. Further, the modification rules for the event obtaining engine (206) may be based on processing security information related to events.

As illustrated, the modified security information is sent from preparing engine two (214-2) to a repository (216) for long term storage. In this example, a storing engine (240) is used to store the modified security information in the repository (216) for a long term analysis by big data threat analytics (218).

In one example, the system (200) analyzes, via big data threat analytics (242), the modified security information to create a number of metrics and identify security threats. In one example, the system (200) uses an analyzing engine (242) to analyze, via the big data threat analytics (218), the modified security information to create the number of metrics and identify the security threats. As illustrated in FIG. 2, the modified security information stored in the repository (216) may be analyzed by the big data threat analytics (218). In one example, the big data threat analytics (218) computes current security threats. In this example, the big data threat analytics (218) calculates and provisions a wide set of strategic metrics. In one example, the metrics may be about global threats, customer-based, predictive what-if metrics, IT metrics, other metrics, or combinations thereof. In one example, these metrics are based on statistical and threat analysis of data gathered from IT security event and log management systems, results of predictive simulations, and the outputs of unstructured data. Further, the metrics are conveyed to customers via security reports to illustrate trends and provide benchmarks among a community of customers, to improve strategic security risk assessment.

In one example, the the big data threat analytics (218) uses an analytics library (220) to calculate statistics, identify new security threats based on predefined threat indicators, for example, potential bad clients within the organisation accessing compromised sites, and translates them into metrics that are used both for reporting purposes and as parameters within a model-based predictive analytics (222). Similarly, information extracted from repository (216) by the big data threat analytics (218) is further processed to identify suitable metrics and as model parameters, for example, percentage of disgruntled employees within an organisation, based on their social media and blog posting. As a result, the output of big data analytics (218) provides metrics and security threats that reflect the reality of the customer network's environment. As illustrated in FIG. 2, the metrics produced by the big data threats analytics (218) are injected into a refining model (232). In one example, the refining model (232) receives metrics from the big data threats analytics (218) that may be based on a statistical and threat analysis of security information gathered from IT security event and log management systems, results from predictive simulations, outputs of unstructured data, other system, or combinations thereof. In this example, the refining model (232) may refine the metrics according to rules, common techniques, a current state of the customer network (202), or combinations thereof such that the refined metrics update parameters of system models stored in the model library (224). This provides valuable refined metrics for the the model-based predictive analytics (222) such that the predictions are based on validated input reflecting the reality of the customer network's environment.

As illustrated the system (200) includes the model-based predictive analytics (222). In one example, the model-based predictive analytics (222) includes a simulator of predictive models that execute over a simulated time period to make longer term predictions to determine future security threats. Further, the model-based predictive analytics (222) provides in-depth risk analysis and longer-term what-if predictions, in core areas such as vulnerability and threat management (VTM), identity and access management (IAM), and incident and remediation management (IRM), other core areas, or combinations thereof. As a result, the VTM, IAM, and IRM may be predicted security threats based on what-if analysis and simulations. The model-based predictive analytics (222) is based on discrete-event system modelling and simulations. In one example, the model-based predictive analytics (222) may use a system model stored in a model library (224) for in-depth risk analysis and longer-term what-if predictions for security threats. A system model consists of various parameters in the form of probability distributions, likelihoods, event arrival rates, process steps timescales, or durations, along with system and process descriptions captured in the form of diagrams. In one example, parameters are initialized with values that correctly reflect the current state of security controls and the organizational processes to be assessed. Only then can inferences be drawn from simulations, using the system model, for the assessment of risk.

As a result, the model-based predictive analytics (222) is a mechanism that provides what-if assessments of an organization's security processes. This is achieved by a system model, from the model library (224), which produces a process mapping of a client's security processes and captures the security threats to the customer network (202). These are input into the system model with temporal parameters that condition its probability distributions. In one example, the system model is executed as a Monte-Carlo style discrete event simulation. In this example, the Monte-Carlo style simulation executes in order to generate statistically significant results that sample the probability distributions enough so that clients can be advised with confidence of necessary changes to their security processes. In one example, the results may be generated based on experiments verses simulation runs. As such, the simulation runs can take a long time to execute to the point of satisfying statistical criteria. The results are in the form of probabilities and statistics and need analysis by a statistically-aware security consultant. Once interpreted, the analysis is used to provide a what-if risk assessment of changes to an organization's security strategy, be that a technology at a logical level, resourcing, or process change.

As a result, the model-based predictive analytics (222) may execute system models, from the model library (224), in a simulation, to generate predictive analytics. The predictive analytics themselves may be metrics that can be used in for a security report. As will be described below, the security report may include any combination of historical and/or benchmarking metrics that have been generated by the big data threat analytics (218), the model-based predictive analytics (222), or combinations thereof.

The system (200) creates, based on the refined number of metrics used as an input for model-based predictive analytics and the security threats, a security report representing security intelligence for the customer network (202). In one example, the system (200) creates the security report based on the refined metrics. In one example, the security report may be created by a creating engine (226). As mentioned above, the security report includes historical reports and benchmarking reports, inclusive of computed metrics and findings, and is used as security intelligence.

Further, the system (200) displays the security report. In one example, a displaying engine (228) may receive the security report from the creating engine (226). In this example, the displaying engine (228) interfaces with a number of user devices to display the security report. For example, the system (200) may include a user device (232) with a display (234). In this example, the security report may be displayed via the display (234) of the user device (232).

An overall example of a VTM for the customer network (202) will now be described. For a given customer, the system (200) extracts security information from the event obtaining engine (206) regarding the patching of the customer network's devices for given software vulnerabilities. In one example, the system (200) correlates the security information with an external data source such as an open source vulnerability database to further get security information about the customer network's vulnerabilities. The security information is prepared by preparing engine one (214) and stored in the repository (216) as modified security information via the storing engine (240).

The big data threat analytics (218) uses the analytics library (220) for the modified security information to estimate a cumulative curve describing the customer's patch take-up curve. The patch take-up curves estimates how quickly the customer's patches the entire set of its systems in the customer network (202). Further, the big data threat analytics (218) provides trend analysis, for example, how the cumulative curve evolves over a long period of time, and a benchmark graph comparing the estimated cumulative curve against the aggregated cumulative curve obtained from other customers. By querying unstructured data sources, in the unstructured data obtaining engine (210), such as security forum posts, the system (200) further annotates this information against indicators of growth exploitation rates for critical vulnerabilities. All these metrics can be conveyed to customers via reports.

Further, these metrics are also used for predictions and what-if analysis by the model-based predictive analytics (222). For example, all these metrics may be sent from the big data threat analytics (218) to a refining model (232). As mentioned above, the refining model (232) refines the metrics according to rules, common techniques, a current state of the customer network (202), or combinations thereof such that the refining model produce refined metrics. In one example, the refined metrics updates parameters for system models in a model library (224). Further, given the calculated patch take-up curve for a given customer, a system model, from the model library (224), can be used to assess the impact of deploying additional controls within the customer network, such as intrusion detection systems, and provide recommendations on the best way to remediate associated security threats via a security report. The creating engine (226) creates the security report as described above. Further, the displaying engine (228) displays the security report. In one example, the security reports includes various computed metrics, detected threat indicators, predictions and benchmarking reports to provide the relevant security intelligence shared with customers.

While this example has been described with reference to the system (200) including the event obtaining engine (206) and the unstructured data obtaining engine (210), the system (200) may include other obtaining engines, or combinations thereof. For example, the system (200) includes the unstructured data obtaining engine (210). In another example, the system (200) includes the event data obtaining engine (210).

While this example has been described with reference to the system (200) creating a security report, such as a historical report or a benchmark report, the system (200) may create other types of reports. For example, the security report can be based on any type of input, inclusive of metrics computed by the big data threat analytics, the model-based predictive analytics, or combinations thereof.

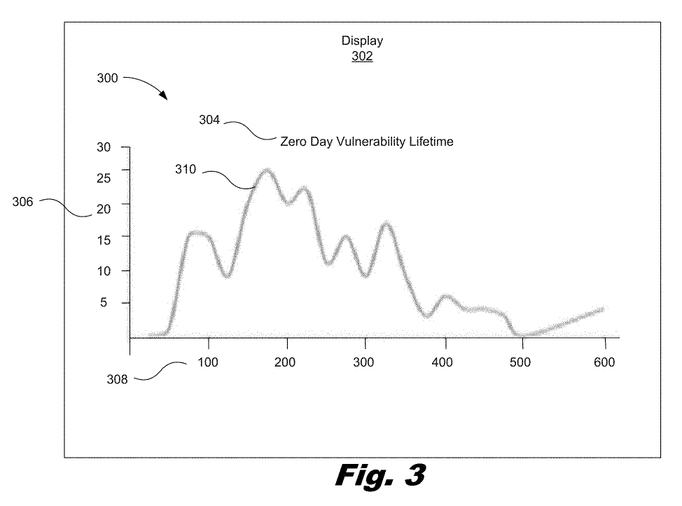

FIG. 3 is a diagram of an example of a security report for a customer network, according to one example of principles described herein. As mentioned above, the creating system displays the security report, the security report representing security intelligence for the customer network. In one example, a displaying engine may receive the security report from the creating engine of FIG. 2. In this example, the displaying engine interfaces with a display of a user device to display the security report.

FIG. 3 illustrates a security report (300). In this example, the security report (300) is displayed via a display (302). As illustrated, the security report (300) includes a title (304). In this example, the title (304) may be zero day vulnerability lifetime. As a result, the security report (300) is about zero day vulnerability lifetime. Further, the security report (300) includes a Y axis (306). In this example, the Y axis (306) may be a frequency such as a number of times a security threat is detected. Further, the security report (300) includes an X axis (308). In this example, the X axis (308) may be a duration of time such as days. As, a result, the security report (300) displays zero day vulnerability lifetime information (310) as a function of frequency and time.

While this example has been described with reference to the display displaying a zero day vulnerability lifetime security report, the display may display a patch uptake security report, a risk exposure window security current report, a risk exposure window what-if security report, a benchmarking of patch up-takes across industry security report, other security reports, or combinations thereof. Further, the security report may include several diagrams related to several metrics of various types and may be based on historical and benchmarking processing.

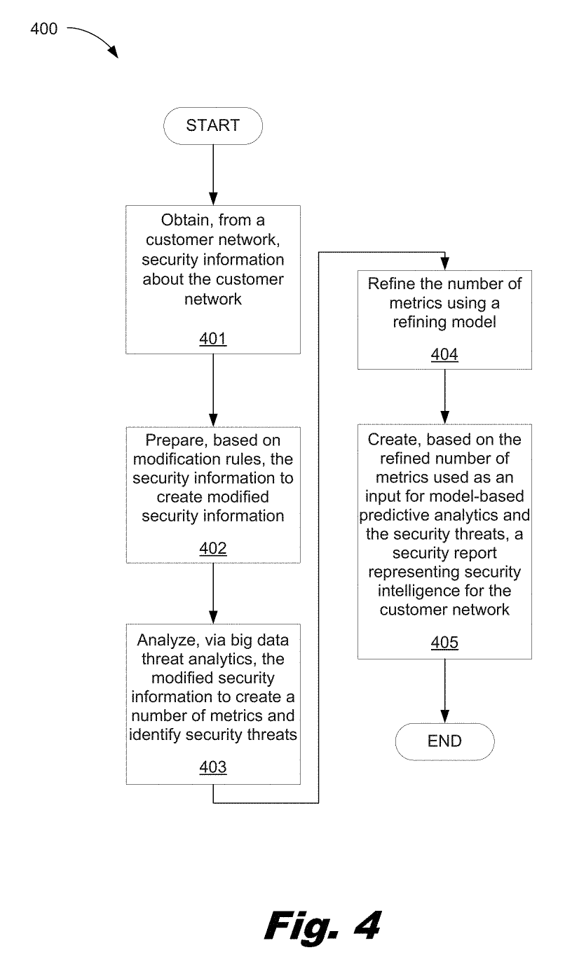

FIG. 4 is a flowchart of an example of a method for creating a security report for a customer network, according to one example of principles described herein. In one example, the method (400) may be executed by the system (100) of FIG. 1 or the system (200) of FIG. 2. In other examples, the method (400) may be executed by other systems such as system 600 or system 700. In this example, the method (400) includes obtaining (401) from a customer network, security information about the customer network, preparing (402), based on modification rules, the security information to create modified security information, analyzing (403), via big data threat analytics, the modified security information to create a number of metrics and identify security threats, refining (404), the number of metrics using a refining model, and creating (405), based on the refined number of metrics used as an input for model-based predictive analytics and the security threats, a security report representing security intelligence for the customer network.

As mentioned above, the method (400) includes obtaining (401) from a customer network, security information about the customer network. In one example, the security information includes unstructured data, events related to the customer network, or combinations thereof.

As mentioned above, the creating system of FIG. 1 obtains, from the customer network, security information about the customer network. As mentioned above, the security information may be data related to the customer network that represents a state of security for the customer network. In this example, the security information may be obtained from an event obtaining engine.

In one example, the event obtaining engine includes a SIEM event collector. In one example, the SIEM event collector actively receives network based security logs and events from the customer network. In one example, the SIEM event collector may include analytics to aid the system of FIG. 2 in obtaining security information about the customer network. As, a result, the event obtaining engine may be used to obtain, from the customer network, security information about the customer network.

In another example, an unstructured data obtaining engine may be used to obtain, from the customer network, security information about the customer network. In this example, the unstructured data obtaining engine may include a SIEM unstructured data collector may to obtain, from the customer network, security information about the customer network. In this example, the SIEM unstructured data collector may obtain unstructured data such as sentiments from users uploading data to a social media service on the customer network. In one example, the SIEM unstructured data collector may include analytics to aid the system to obtain from the customer network the unstructured data. As a result, the unstructured data obtaining engine may be used to obtain, from the customer network, security information about the customer network.

As mentioned above, the method (400) includes preparing (402), based on modification rules, the security information to create modified security information. Once the security information is obtained via the event obtaining engine or the unstructured data obtaining engine, the security information may be further processed by a number of preparing engines such as prepare engine one and prepare engine two of FIG. 2. Preparing engine one prepares the security data from the event obtaining engine. In one example, preparing engine one prepares the security data from the event obtaining engine based on modification rules, the security information to create modified security information. In one example, the modification rules may identify specific users, organizations, devices, systems, and services that have posed a security threat to the customer network in past situations. Further, preparing engine two prepares the security data from the unstructured data obtaining engine. In one example, preparing engine two prepares the security data from the unstructured data obtaining engine based on based on modification rules, the security information to create modified security information. In one example, the modified security information is sent from the preparing engines to a repository for long term storage.

As mentioned above, the method (400) includes analyzing (403), via big data threat analytics, the modified security information to create a number of metrics and identify security threats. In one example, the big data threat analytics calculates statistics, identifies new security threats based on predefined threat indicators, translates the statistics and the new security threats into the number of metrics, analyzes the security threats, or combinations thereof. In one example, analyzing, via big data threat analytics, the modified security information to create a number of metrics and identify security threats may be implemented by the system of FIG. 2.

As mentioned above, the method (400) includes refining (404), the number of metrics using a refining model. As mentioned above, a refining model receives metrics from the big data threats analytics. In one example, the metrics may be based on a statistical and threat analysis of security information gathered from IT security event and log management systems, results from predictive simulations, outputs of unstructured data, other system, or combinations thereof. In this example, the refining model refines the metrics according to rules, common techniques, a current state of the customer network, or combinations thereof such that the refined metrics update parameters of system models stored in the model library. For example, the refining model refines the metrics according to rules by determining if a metrics is to be refined or not. The rules may be based on a time, specific users, devices, system, or combinations thereof. Further, the refining model refines the metrics according the current state of the customer network. For example, if specific users, devices, system, or combinations thereof are connected to the customer network, the refining model refines the metrics accordingly. In this example, the specific users, devices, system, or combinations thereof that are connect to the network may or may not pose a security threat. As a result, the refining model provides valuable refined metrics for the the model-based predictive analytics (222) such that the predictions are based on validated input reflecting the reality of the customer network's environment.

As mentioned above, the method (400) includes creating (404), based on the refined number of metrics used for model-based predictive analytics and the security threats, a security report representing security intelligence for the customer network. In one example, based on the number of metrics used for model-based predictive analytics and the security threats, a security report may be implemented by the system of FIG. 2. Further, the model-based predictive analytics identifies the security threats for VTM, zero day threats, IAM, IRM, or combinations thereof.

In one example, VTM may be used to understand how quickly a client's desktop estate is patched. By processing data collected in system logs, the method (400) is able to produce statistics showing the performance of patch uptake, with live and historical views. By utilizing statistics for other clients, an analyst can provide further value to the client by providing them with an assessment of their position relative to the norm. This can help in decisions on the merit of patching targets versus reliance on other mitigating controls. For example, a telecommunications governing authority currently needs one-hundred percent patching which is often hard to achieve and possibly even undesirable. In this example, metrics such as patch uptake and risk exposure may be used in the method (400).

In one example, information related to zero day threats and other security sources can be used to provide predictions of when related vulnerabilities will be publicly disclosed. For example, zero day threats may be used to track data sources to provide useful date for publically-disclosed vulnerabilities to a customer network. By tracking these publically-disclosing vulnerabilities to vendors and to the public, the method (400) can assess the reaction times of vendors and help to apply pressure where appropriate. An analyst can, using this information, present a detailed picture of the zero-day market evolution for a client. In this example, metrics such as global zero day threat and risk exposure may be used by the method (400).

In one example, IAM may correlate user accounts against details of employees who have left an organization. The method (400) may provide statistics regarding potential and actual misuse of IT accounts. As a result, hanging accounts may be reduced and the potential for insider and external abuse may also be reduced. In this example, metrics such as time to remove account and risk exposure due to deprovisioning time and misuse of credentials may be used by the method (400).

In one example, IRM may be used to capture process steps within the system of FIG. 2. The system of FIG. 2 may be used to illustrate how the process steps can be modified to achieve more effective outcomes for the customer network. As a result, security threats related to the process steps may be reduced.

Further, the method (400) may display the security report. In one example, a displaying engine may receive the security report form the creating engine. In this example, the displaying engine interfaces with a number of user devices to display the security report.

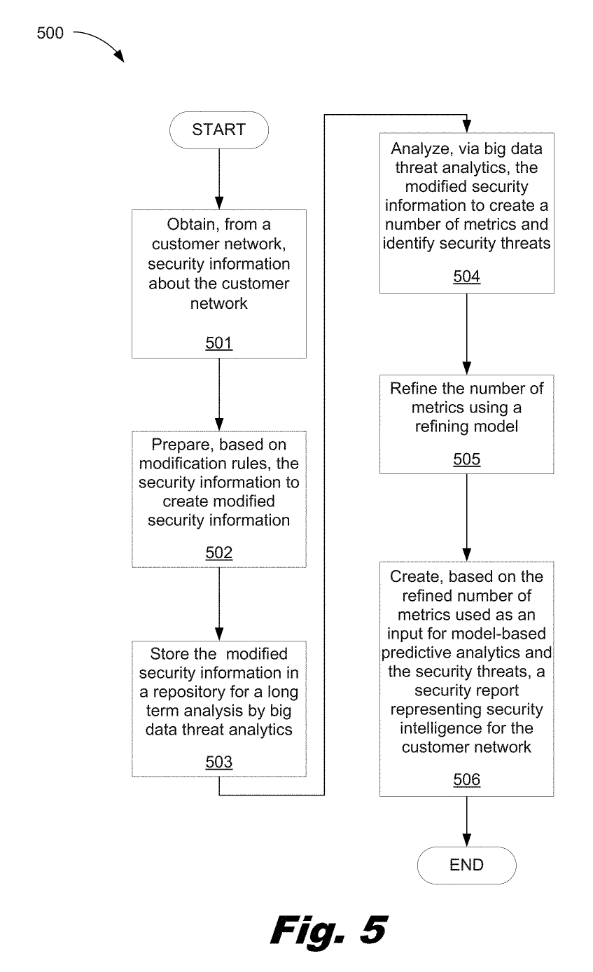

FIG. 5 is a flowchart of an example of a method for creating a security report for a customer network, according to one example of principles described herein. In one example, the method (500) may be executed by the system (100) of FIG. 1 or the system (200) of FIG. 2. In other examples, the method (500) may be executed by other systems such as system 600 or system 700. In this example, the method (500) includes obtaining (501) from a customer network, security information about the customer network, preparing (502), based on modification rules, the security information to create modified security information, storing (503) the modified security information in a repository for a long term analysis by big data threat analytics, analyzing (504), via the big data threat analytics, the modified security information to create a number of metrics and identify security threats, refining (505) the number of metrics using a refining model, and creating (505), based on the refined number of metrics used as an input for model-based predictive analytics and the security threats, a security report representing security intelligence for the customer network.

As mentioned above, the method (500) includes storing (503) the modified security information in a repository for a long term analysis by big data threat analytics. In one example, the modified security information are stored, via a storing engine, in a repository for a specific amount of time such as a day, a week, a year, other measurements of time, or combinations thereof. As a result, the modified security information may be analyzed over a specific amount of time.

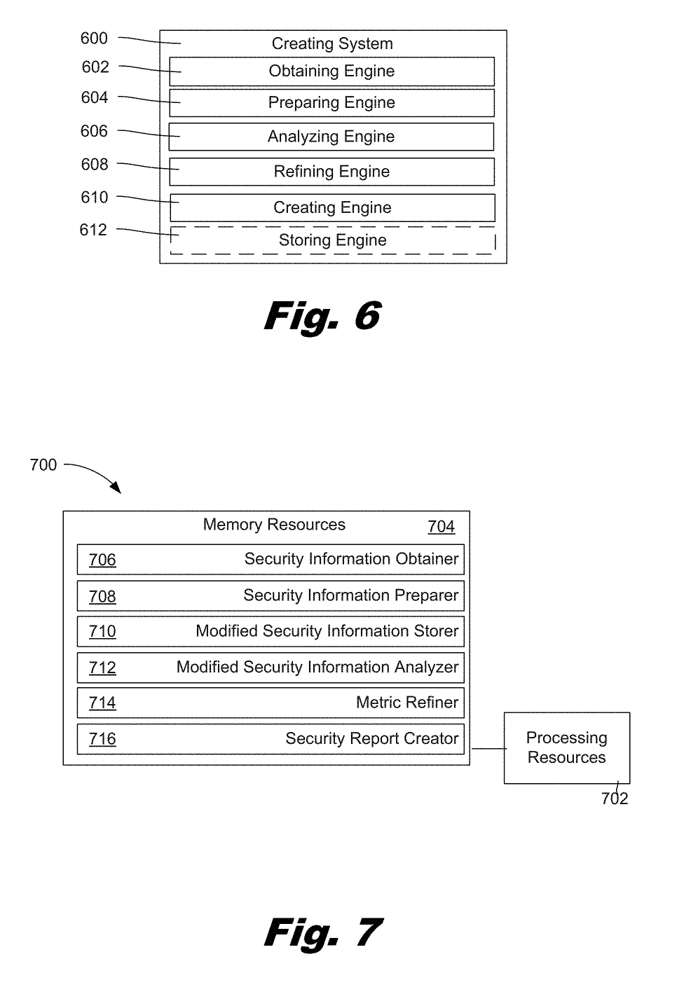

FIG. 6 is a diagram of an example of a creating system (600), according to one example of principles described herein. The creating system (600) includes an obtaining engine (602), a preparing engine (604), an analyzing engine (606), a refining engine (608), and a creating engine (610). In this example, the creating system (600) also includes a storing engine (612). The engines (602, 604, 606, 608, 610, 612) refer to a combination of hardware and program instructions to perform a designated function. Each of the engines (602, 604, 606, 608, 610, 612) may include a processor and memory. The program instructions are stored in the memory and cause the processor to execute the designated function of the engine.

The obtaining engine (602) obtains, from a customer network, security information about the customer network. In one example, the security information includes unstructured data, events related to the customer network, or combinations thereof. Further, the obtaining engine (602) may include the event obtaining engine of FIG. 2, the unstructured data obtaining engine of FIG. 2, or combinations thereof.

The preparing engine (604) prepares, based on modification rules, the security information to create modified security information. In one example, the preparing engine (604) prepares, based on one modification rule, the security information to create modified security information. In another example, the preparing engine (604) prepares, based on several modification rules, the security information to create modified security information.

The analyzing engine (606) analyzes, via big data threat analytics, the modified security information to create a number of metrics and identify security threats. In one example, the big data threat analytics calculates statistics, identifies new security threats based on predefined threat indicators, translates the statistics and the new security threats into the number of metrics, or combinations thereof.

The refining engine (608) refines, the number of metrics using a refining model. In one example, the refining model produces refined metrics. In this example, the refined metrics update parameters of system models stored in a model library.

The creating engine (610) creates, based on the refined number of metrics used as an input for model-based predictive analytics and the security threats, a security report representing security intelligence for the customer network. In one example, the model-based predictive analytics identifies the security threats for VTM, IAM, IRM, or combinations thereof. In one example, the security report includes a historical report, a benchmarking report, or combinations thereof for the customer network.

The storing engine (612) stores the modified security information in a repository for a long term analysis by the big data threat analytics. In one example, the storing engine (612) stores the modified security information in a repository for a specific amount of time such as a day, a week, a year, other measurements of time, or combinations thereof.

FIG. 7 is a diagram of an example of a creating system (700), according to one example of principles described herein. In this example, creating system (700) includes processing resources (702) that are in communication with memory resources (704). Processing resources (702) include at least one processor and other resources used to process programmed instructions. The memory resources (704) represent generally any memory capable of storing data such as programmed instructions or data structures used by the creating system (700). The programmed instructions shown stored in the memory resources (704) include a security information obtainer (706), a security information preparer (708), a security threat storer (710), a security threat analyzer (712), a metric refiner (714), and a security report creator (716).

The memory resources (704) include a computer readable storage medium that contains computer readable program code to cause tasks to be executed by the processing resources (702). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The security information obtainer (706) represents programmed instructions that, when executed, cause the processing resources (702) to obtain, from a customer network, security information about the customer network. The security information preparer (708) represents programmed instructions that, when executed, cause the processing resources (702) to prepare, based on modification rules, the security information to create modified security information.

The security threat storer (710) represents programmed instructions that, when executed, cause the processing resources (702) to store the modified security information in a repository for a long term analysis by the big data threat analytics. The security threat analyzer (712) represents programmed instructions that, when executed, cause the processing resources (702) to analyze, via big data threat analytics, the modified security information to create a number of metrics and identify security threats.

The metric refiner (714) represents programmed instructions that, when executed, cause the processing resources (702) to refine the number of metrics using a refining model. The security report creator (716) represents programmed instructions that, when executed, cause the processing resources (702) to create, based on the refined number of metrics used as an input for model-based predictive analytics and the security threats, a security report representing security intelligence for the customer network.

Further, the memory resources (704) may be part of an installation package. In response to installing the installation package, the programmed instructions of the memory resources (704) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (702) and the memory resources (702) are located within the same physical component, such as a server, or a network component. The memory resources (704) may be part of the physical component's main memory, caches, registers, non-volatile memory, or elsewhere in the physical component's memory hierarchy. Alternatively, the memory resources (704) may be in communication with the processing resources (702) over a network. Further, the data structures, such as the libraries, may be accessed from a remote location over a network connection while the programmed instructions are located locally. Thus, the creating system (700) may be implemented on a user device, on a server, on a collection of servers, or combinations thereof.

The creating system (700) of FIG. 7 may be part of a general purpose computer. However, in alternative examples, the creating system (700) is part of an application specific integrated circuit.

The preceding description has been presented to illustrate and describe examples of the principles described. This description is not intended to be exhaustive or to limit these principles to any precise form disclosed. Many modifications and variations are possible in light of the above teachings.

What is claimed is:

1. A method for creating a security report for a customer network, the method comprising:
obtaining, from a customer network, security information about the customer network;
preparing, based on modification rules, the security information to create modified security information;
analyzing, via big data threat analytics, the modified security information to create a number of metrics and identify security threats;
refining the number of metrics using a refining model; and
creating, based on the refined number of metrics used as an input for model-based predictive analytics and the security threats, a security report the security report representing security intelligence for the customer network.

2. The method of claim 1, in which the security information comprises unstructured data, events related to the customer network, or combinations thereof.

3. The method of claim 1, in which the model-based predictive analytics identifies the security threats for vulnerability and threat management (VTM), identify and access management (IAM), incident and remediation management (IRM), or combinations thereof.

4. The method of claim 1, in which the security report comprises a historical report, a benchmarking report, or combinations thereof for the customer network.

5. The method of claim 1, further comprising storing the modified security information in a repository for a long term analysis by the big data threat analytics.

6. The method of claim 1, in which the big data threat analytics calculates statistics, identifies new security threats based on predefined threat indicators, translates the statistics and the new security threats into the number of metrics, analyzes the security threats, or combinations thereof.

7. A system for creating a security report for a customer network, the system comprising:
an obtaining engine to obtain, from a customer network, security information about the customer network;
a preparing engine to prepare, based on modification rules, the security information to create modified security information;
a storing engine to store the modified security information in a repository for a long term analysis by a big data threat analytics;
an analyzing engine to analyze, via the big data threat analytics, the modified security information to create a number of metrics and identify security threats;
a refining engine to refine the number of metrics using a refining model; and
a creating engine to create, based on the refined number of metrics used as an input for model-based predictive analytics and the security threats, a security report representing security intelligence for the customer network.

8. The system of claim 7, in which the security information comprises unstructured data, events related to the customer network, or combinations thereof.

9. The system of claim 7, in which the model-based predictive analytics identifies the security threats for vulnerability and threat management (VTM), identify and access management (IAM), incident and remediation management (IRM), or combinations thereof.

10. The system of claim 7, in which the security report comprises a historical report, a benchmarking report, or combinations thereof for the customer network.

11. The system of claim 7, in which the big data threat analytics calculates statistics, identifies new security threats based on predefined threat indicators, translates the statistics and the new security threats into the number of metrics, analyzes the security threats, or combinations thereof.

12. A computer program product for creating a security report for a customer network, comprising:
a tangible computer readable storage medium, said tangible computer readable storage medium comprising computer readable program code embodied therewith, said computer readable program code comprising program instructions that, when executed, causes a processor to:
prepare, based on modification rules, security information to create modified security information;
analyze, via big data threat analytics, the modified security information to create a number of metrics and identify security threats;
refine the number of metrics using a refining model; and
create, based on the refined number of metrics used as an input for model-based predictive analytics and the security threats, a security report representing security intelligence for the customer network.

13. The product of claim 12, further comprising computer readable program code comprising program instructions that, when executed, cause said processor to obtain, from the customer network, the security information about the customer network.

14. The product of claim 12, further comprising computer readable program code comprising program instructions that, when executed, cause said processor to store the modified security information in a repository for a long term analysis by the big data threat analytics.

15. The product of claim 12, in which the model-based predictive analytics identifies the security threats for vulnerability and threat management (VTM), access management (IAM), incident and remediation management (IRM), or combinations thereof and in which the big data threat analytics calculates statistics, identifies new security threats based on predefined threat indicators, translates the statistics and the new security threats into the number of metrics, analyzes the security threats, or combinations thereof.
